(19) United States
(12) Patent Application Publication
(10) Pub. No.: US 2017/0247101 A1
(43) Pub. Date: Aug. 31, 2017

(54) Unified floor and aircraft nose including such a floor, and method for incorporating such a nose

(71) Applicant: Airbus Operations SAS, Toulouse (FR)

(72) Inventor: Bernard Guering, Montrabe (FR)

(21) Appl. No.: 15/441,496

(22) Filed: Feb. 24, 2017

(30) Foreign Application Priority Data
Feb. 25, 2016 (FR) 1651562

(51) Int. Cl. B64C 1/18; B64F 5/10

(52) U.S. Cl. CPC B64C 1/18; B64F 5/10

(57) ABSTRACT

An aircraft nose floor comprising a grid structure formed by an interlacing of crosspieces and longitudinal elements. The crosspieces are parallel to one another and the longitudinal elements are parallel to one another and fastened to the crosspieces. The floor forms a unified module configured to be transported in one piece to the inside of an aircraft nose during the integration phase. The integration time is reduced, and the operators' tasks are made easier.

### CROSS-REFERENCES TO RELATED APPLICATIONS

This application claims the benefit of the French patent application No. 1651562 filed on Feb. 25, 2016, the entire disclosures of which are incorporated herein by way of reference.

### FIELD OF THE INVENTION

The invention relates to an aircraft nose floor, an aircraft nose including an aircraft nose floor and a method for incorporating a floor of an aircraft nose.

In a commercial aircraft, the nose comprises the part of the aircraft that is said to have an evolving section, i.e., the front part of the aircraft whose cross-section has a geometry that is not constant, but evolves along the longitudinal axis of the aircraft (front evolving geometry). The aircraft nose extends from the front tip of the aircraft toward the rear of the aircraft, including the cockpit.

### BACKGROUND OF THE INVENTION

The nose comprises a floor that separates an upper zone situated above the floor from a lower zone situated below the floor. The part of this floor that is closest to the front tip of the aircraft forms the cockpit floor.

When the nose is incorporated, the floor is built in situ over the course of the construction of the aircraft fuselage.

The nose comprises an avionics bay that extends from the lower zone situated below the cockpit toward the rear of the front part.

A front landing gear box is arranged in the avionics bay, below the cockpit floor. This arrangement results in splitting the zone of the avionics bay into several independent work zones.

Many pieces of equipment and material are present in these zones, which makes the operations to incorporate the front part particularly time-consuming and tedious.

Such an integration phase is therefore incompatible with increasing aircraft production rhythms.

### SUMMARY OF THE INVENTION

According to a first aspect, the invention thus relates to an aircraft nose floor, characterized in that the floor comprises a grid structure formed by interlacing crosspieces parallel to one another and longitudinal elements parallel to one another and fastened to the crosspieces, the grid structure incorporating cables and/or conduits that are fastened to the structure, the floor and the cables and/or conduits forming a unified module that is configured to be transported in a single piece, the cables and/or conduits incorporated into the structure being grouped together in several separate sets of cables and/or conduits, the structure having a height that extends perpendicular to the extension directions of the crosspieces and longitudinal elements, the separate sets of cables and/or conduits respectively extending in separate extension planes that are respectively distributed with different altitudes relative to the height of the structure.

The component elements of the floor (parallel crosspieces and longitudinal elements, such as rails) are assembled to one another outside the nose of the aircraft, in a cleared space. In such a space, spatial bulk constraints do not arise and the tasks of operators that were previously carried out in the nose during integration are therefore greatly simplified. The floor structure thus assembled beforehand also integrates separate sets of cables and/or conduits distributed in different planes or layers. This preassembled structure forms a unified assembly or module that can be moved in a single piece.

Such an assembled unified floor structure can thus be introduced into the nose of the aircraft in a single operation. All that remains is then to fasten the structure to the nose.

According to other possible features, considered alone or in combination with one another:
the separate sets of cables and/or conduits are each situated in a different geometric zone relative to the structure;
the extension planes of the separate sets of cables and/or conduits are parallel to one another and situated at different altitudes from one another, each set including several cables and/or conduits or several subsets of cables and/or conduits that extend parallel to one another in a same plane and at a same altitude;
the separate sets of cables and/or conduits are positioned so as to intersect one another;
at least one set of cables and/or conduits is positioned parallel to the crosspieces and at least one set of cables and/or conduits is positioned parallel to the longitudinal elements;
at least one set of cables and/or conduits is fastened to crosspieces and at least one set of cables and/or conduits is fastened to longitudinal elements;
several crosspieces each comprise a lower soleplate and an upper soleplate and are each provided, at each soleplate, with at least one fastening support for fastening at least one cable and/or conduit of a set of cables and/or conduits that extends parallel to the longitudinal elements;
each longitudinal element is provided, in its lower part, with at least one support for fastening a set of cables and/or conduits that extends parallel to the crosspieces.

According to a second aspect, the invention also relates to an aircraft nose, characterized in that it comprises a floor as briefly described above.

According to other possible features:
the nose extends longitudinally and comprises a plurality of transverse fuselage frames parallel to one another that surround the floor, each fuselage frame extending in a cross-section and bordering, by an inner peripheral edge, a central opening, at least some of the crosspieces of the floor each being fastened by their two opposite ends respectively to two facing radial protuberances of a fuselage frame, the two protuberances of the frame extending radially in the central opening of the frame toward one another from the inner peripheral edge of the frame;
each crosspiece of the floor has a length smaller than the longest transverse distance that extends between two diametrically opposite zones of the inner peripheral edge of each frame that the crosspiece has traversed to place the floor;
the two radial protuberances of each frame are respectively situated at an altitude lower than that of the two diametrically opposite zones of the inner peripheral edge of each frame;
the floor comprises one or several intermediate brackets for at least some of the crosspieces, the intermediate bracket(s) being positioned below the crosspieces.

According to a third aspect, the invention also relates to a method for integrating a floor of an aircraft nose, the nose defining an inner space to be integrated that extends along a longitudinal axis, the inner space to be integrated being open at a so-called rear end of the nose and closed at an opposite front end of the nose, characterized in that the method includes the following steps:
inserting a nose floor as briefly described above into the nose, the insertion of the floor being done along the longitudinal axis via the rear end of the nose,
moving the floor in the inner space to be integrated, toward the front end of the nose until reaching a location reserved to accommodate the floor.

According to other possible features:
the nose comprises a plurality of parallel transverse fuselage frames, each fuselage frame extending in a cross-section and bordering, by an inner peripheral edge, a central opening, the crosspieces of the floor each having a length that is smaller than the largest transverse distance that extends between two diametrically opposite zones of the inner peripheral edge of each frame such that the crosspieces of the floor pass between the frames, at the altitude of the two diametrically opposite zones of each frame, called crosspiece passage zones, during the forward movement of the floor toward the front end of the nose;
each frame including two facing radial protuberances that extend radially in the central opening of the frame toward one another from the inner peripheral edge of the frame, the two radial protuberances of each frame being situated at an altitude lower than that of the two crosspiece passage zones and forming docking support zones for the crosspieces, the method comprises, after the passage of the floor between the frames to which the floor must be fastened, at the altitude of the crosspiece passage zones and toward the front end of the nose, a lowering of the floor to the altitude of the two docking support zones of each traversed frame, then a return backward of the floor so that the two opposite ends of each crosspiece on the one hand are respectively brought against the two docking support zones of the crosspieces of the traversed frame, and on the other hand, fastened to the latter.

### BRIEF DESCRIPTION OF THE DRAWINGS

Other features and advantages will appear in the following description, provided solely as a non-limiting example, and done in reference to the appended drawings, in which:

FIG. 1 is a general schematic perspective top view of a unified floor structure of an aircraft nose according to one embodiment of the invention;

FIG. 2 is a partial schematic perspective top view of the floor structure of FIG. 1;

FIG. 3 is a partial schematic longitudinal sectional view in plane XZ of the structure 10 of FIG. 2 equipped with sets of cables;

FIG. 4 is a perspective view of the inside of the nose from the rear end thereof;

FIG. 5 is a schematic perspective view of the nose during integration of the unified floor of FIG. 1;

FIG. 6 is a partial schematic cross-sectional view of two facing parts of a fuselage frame;

FIG. 7 is a perspective top view of the inside of the nose from the rear end thereof with the unified floor of FIG. 1 installed;

FIGS. 8 and 9 are schematic views similar to the view of FIG. 6 and showing the lowering of a floor crosspiece to the altitude of the lugs of the traversed frame;

FIG. 10 is an enlarged partial schematic view of a frame part provided with a lug and a docked crosspiece end;

FIG. 11 is a flowchart of a method for integrating a floor into a nose according to one embodiment of the invention.

### DETAILED DESCRIPTION OF THE PREFERRED EMBODIMENTS

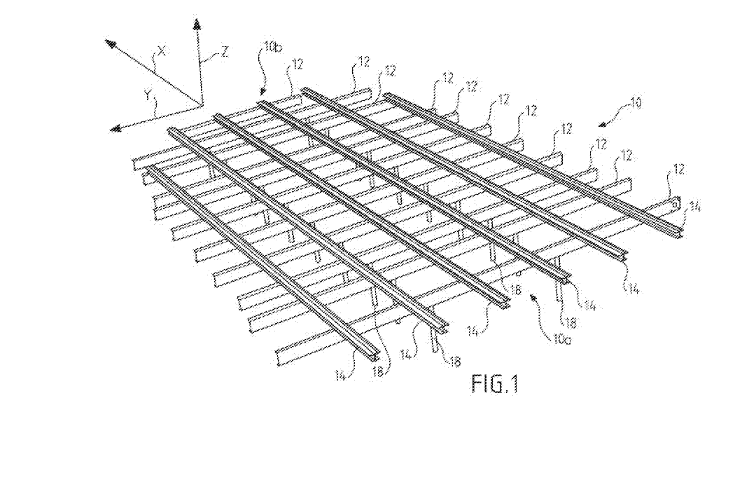

As shown in FIG. 1 and designated by general reference 10, an aircraft nose floor according to one embodiment of the invention comprises:
a plurality of parallel crosspieces 12, positioned in a same plane, and
a plurality of parallel longitudinal elements 14, positioned in a same plane and fastened to the crosspieces 12.

The crosspieces 12 intersect the longitudinal elements 14 so as to form a single-piece (module) or unified grid structure that can be moved in one piece. In the example embodiment shown in FIG. 1, at least most of the crosspieces 12 are spaced regularly apart from one another, and the same is, for example, true for the longitudinal elements 14.

The longitudinal elements 14 are structural elements that are, for example, rails. These rails will be positioned in the direct extension of the rails of the aircraft cabin when the floor has been installed in its final functional position.

The longitudinal elements 14 are for example positioned above the crosspieces 12.

The floor 10 of FIG. 1 (crossed network of crosspieces and longitudinal elements) is thus permanently assembled outside the nose of an aircraft. The floor behaves like a module or unified assembly that can be moved in one piece to be installed in an aircraft nose.

In the example embodiment, the floor nevertheless behaves like a module or unified assembly base inasmuch as its grid structure, in particular, accommodates sets of cables and/or conduits and/or, more generally, other system circuits (such as oxygen conduits), as will be seen later. Everything that is described below for the cables applies to any other type of system circuit (a system circuit is a connecting element between systems internal to the aircraft and that conveys electricity or a fluid, for example to power a system or transport data), such as a conduit conveying a fluid (e.g., oxygen).

As shown in FIG. 1, the interlacing 10 (floor) of crosspieces 12 and longitudinal elements 14 has an elongated general shape along a longitudinal axis X. This axis X will be combined with the longitudinal axis of the aircraft nose when the floor 10 is installed in the nose. The longitudinal elements 14 are parallel to the longitudinal axis X. The floor 10 has a width that is dictated by the length of the crosspieces 12, and a length dictated by the length of the longitudinal elements 14. The width of the crosspieces 12 is substantially constant over the majority of the longitudinal dimension of the floor (at least ⅔ of the longitudinal dimension) from the rear end 10a toward the front end 10b. The width of the crosspieces 12 becomes smaller near the front end 10b (in top view) so as to adapt to the reduced cross-section of the aircraft at the front end of the nose. In other words, the crosspieces have an evolving length due to the evolving shape of at least part of the aircraft noses.

The floor 10 also extends along another dimension or height considered along the vertical axis Z that is perpendicular to the extension directions X of the longitudinal elements 14 and Y of the crosspieces 12. The height of the floor structure 10 is globally dictated by the cumulative height of the crosspieces 12 and the longitudinal elements 14. The height of the crosspieces and the longitudinal elements can be identical.

The grid floor structure 10 itself incorporates a plurality of sets of cables and/or other system circuits (such as conduits or pipes, in particular for oxygen, etc.) that are already fastened to the structure before placement of the latter in the nose of an aircraft.

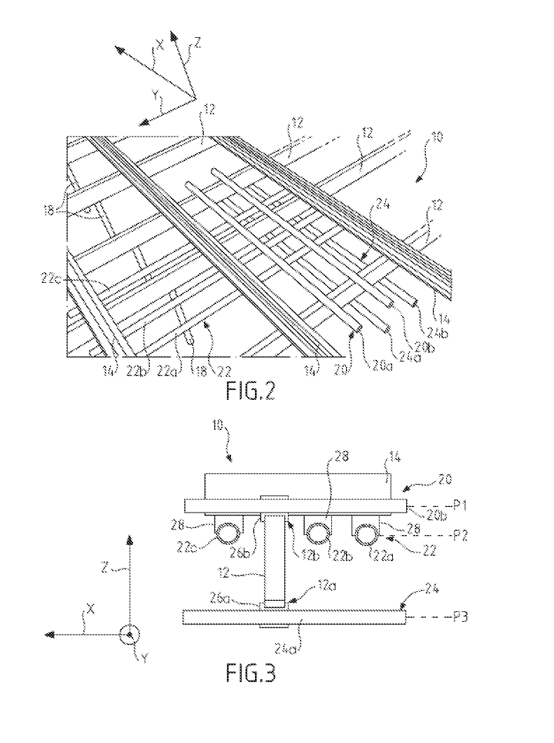

FIG. 2 is a partial schematic perspective top view of the structure 10 of FIG. 1 incorporating several separate sets of electrical cables and/or other system circuits, for example only three of which, denoted 20, 22, 24, are shown for clarity reasons. The number of separate sets of cables fastened to the structure 10 may, however, be different, and, in particular, higher. FIG. 2 shows sets of cables (this may alternatively involve conduits, or cables and conduits). These separate sets of cables are each situated in a different geometric zone relative to the structure. All or some of these sets may be situated in a zone of the structure and/or outside it (for example above, below, next to the structure, etc.). The sets 20, 22 and 24 each comprise several strands that each comprise a plurality of cables (for example, several thousand cables are grouped together per strand). The strands of cables or subsets of cables illustrated in FIG. 2 are referenced 20a-b for the set of cables 20, 22a-c for set 22 and 24a-b for set 24. These sets may include more strands of cables, but only these have been shown in order to avoid overloading the figures.

In each set of cables, all of the strands of cables are, for example, positioned parallel to one another and in a same plane.

FIG. 3 is a longitudinal sectional view in the vertical plane XZ of part of the structure 10 of FIG. 2 equipped with sets 20, 22 and 24.

As shown in FIGS. 2 and 3, the separate sets 20, 22 and 24 respectively extend in extension planes that are distributed along the height of the structure (axis Z). These planes could, however, protrude from the structure above, below and/or on the side thereof.

The respective extension planes P1, P2, P3 of the various sets 20, 22 and 24 are parallel to one another (these planes are parallel to the plane XY) and are situated at different altitudes from one another (superimposed planes), as shown in FIG. 3: the set of cables 20 is situated at a higher altitude (along the axis Z) than that of the set of cables 22, which in turn is situated at a higher altitude than that of the set of cables 24. The planes are generally positioned in the median plane of the cable strands.

As shown in FIGS. 2 and 3, the separate sets 20, 22, 24 are positioned so as to intersect one another, alternating from one set to the immediately adjacent set.

Thus, for example, the cables of the set 20 extend flat along the axis X, while the cables of the set 22 situated immediately below extend flat along the axis Y and the cables of the set 24 situated immediately below the set 22 extend flat again along the axis X.

In general, in a configuration that comprises at least two sets of cables, at least one set of cables is positioned parallel to the crosspieces and at least one set of cables is positioned parallel to the longitudinal elements.

In the present case, two sets of cables, namely 20 and 24, are positioned parallel to the longitudinal elements 14 and a third set of cables, namely 22, is positioned parallel to the crosspieces 12.

In general, in a configuration that comprises at least two sets of cables, at least one set of cables is positioned parallel to the crosspieces and at least one set of cables is positioned parallel to the longitudinal elements. The at least one set of cables that is positioned parallel to the longitudinal elements is fastened to the crosspieces, while the at least one set of cables that is positioned parallel to the crosspieces is fastened to the longitudinal elements.

In the present case, two sets of cables, namely 20 and 24, are fastened to the crosspieces 12 and a third set of cables, namely 22, is fastened to the longitudinal elements 14.

In the present embodiment, each crosspiece 12 (FIG. 2) comprises a lower soleplate 12a and an upper soleplate 12b. Each crosspiece 12 is further provided at each of these soleplates with at least one fastening support 26a for the lower soleplate 12a, and at least one fastening support 26b for the upper soleplate 12b. The fastening support 26a, 26b is, for example, removable and attaches directly to the corresponding soleplate of the crosspiece (the support thus forms a vertical overthickness relative to the crosspiece on bottom and on top in FIG. 2) without requiring piercing, and therefore without damaging the crosspiece. The fastening support 26a, 26b is used to fasten one or several strands of cables of a set of cables that extends parallel to the longitudinal elements 14. The support, known in itself, has a part forming an open housing in which the strand can be inserted forcibly (quickly and safely) so as to be solidly kept at the bottom of the housing and no longer be able to move relative to the latter.

Each bottom (26a) and top (26b) support can thus accommodate one or several strands of cables of the considered set of cables according to the support configuration. The support can, in fact, be elongated along the axis Y along the crosspiece 14 and include several parts spaced apart from one another along the axis Y and each forming a housing open to receive a strand. Alternatively, several bottom supports are positioned next to one another along the lower soleplate (like for the upper soleplate) in order each to accommodate a single cable.

As shown in FIG. 3, the bottom support 26a receives a strand of cables 24a of the set 24 and the top support 26b receives a strand of cables 20b of the set 20.

Each longitudinal element 14 is in turn provided, in its lower part, with at least one support 28 known in itself for fastening a set of cables that extends parallel to the crosspieces. Here, it is the set of cables 22 that is fastened to the longitudinal element 14 of FIG. 3. In the illustrated example, there is one cable support per strand. The supports 28 are spaced apart from one another along the axis X and each fastened below a longitudinal element 14. The supports 28 are positioned on either side of crosspieces that are themselves also fastened to the longitudinal elements 14 from below.

Thus, each strand of each of the sets of cables is fastened either to several crosspieces 12 or to several longitudinal elements 14. The crosspieces or the longitudinal elements to which a same strand is fastened are not necessarily all of the crosspieces or all of the longitudinal elements of the structure 10. For example, a strand that extends along the longitudinal axis X of the structure 10 can be fastened to only some of the crosspieces 12. The same is true with the longitudinal elements 14 for a strand that extends along the longitudinal axis Y of the structure 10.

It will be noted that some strands of the sets of cables do not necessarily extend over the entire length (X) or width (Y) of the floor structure, depending on the pieces of aircraft equipment for which they are intended.

Such a floor structure 10 is thus pre-equipped with cables before it is inserted into the nose of an aircraft.

Furthermore, as shown in FIGS. 1 and 2, the floor structure 10 generally comprises one or several intermediate brackets 18 for at least some of the crosspieces 12. The intermediate bracket(s) 18 are positioned below the crosspieces 12. In the illustrated embodiment, the crosspieces 12 of the floor are supported by several intermediate brackets 18 (with the exception, however, of the first one at the front end 10b of the floor, and which is much shorter than the others), and, for example, by two brackets 18. Each intermediate bracket 18 is, for example, a bracket connecting rod, which, in turn, will bear on the landing gear box of the nose.

FIG. 4 shows a perspective view of the inside of a nose 30 of an aircraft, seen from the open rear end of the nose. FIG. 5 shows a simplified perspective bird's eye view of the nose 30 from outside the aircraft 31.

The nose 30 extends along the longitudinal axis X and comprises a fuselage structure 33 that comprises a plurality of transverse fuselage planes 35 parallel to one another.

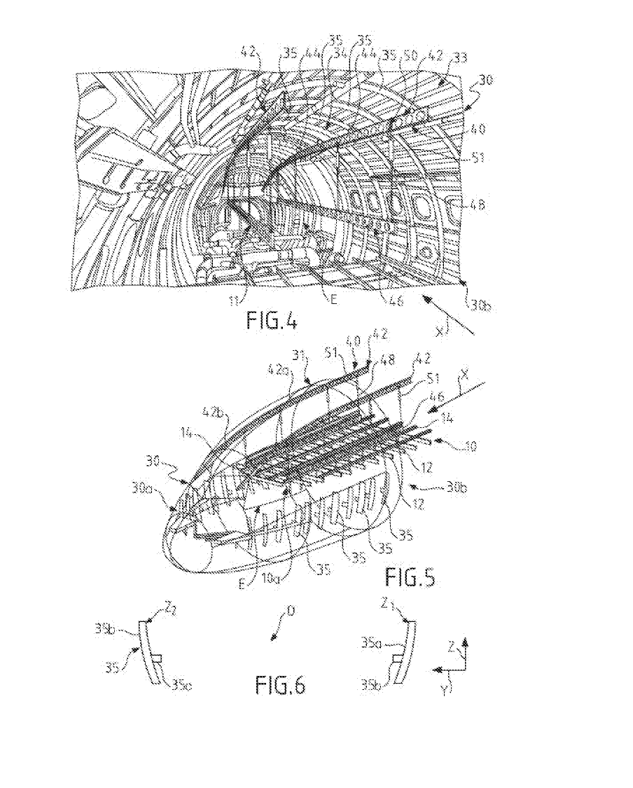

Each fuselage frame 35 has a generally ring-shaped core that extends in a cross-section (plane YZ) and borders, by an inner peripheral edge, a generally circular central opening. The central opening O defined by the inner peripheral edge 35a of a frame 35 is partially illustrated in FIG. 6, which is a cross-sectional view of a frame part. Only two separated facing parts of the frame 35 are shown. All of the frames 35 of the nose 30, for example, have the structure shown in FIG. 6, but with varying dimensions based on the location of the frame in the nose.

The frame 35 of FIG. 6 includes a core 35b and two radial protuberances 35c, 35d or offsetting lugs that are situated facing one another. The two lugs 35c, 35d extend radially (plane YZ) in the central opening O of the frame, toward one another from the inner peripheral edge 35a of the core of the frame. The two lugs 35c, 35d form docking support zones of the crosspieces, as will be seen later. These lugs 35c, 35d are situated in a part of the frame where the horizontal transverse distance between the opposite edges of the frame (excluding lugs) is smaller than the maximum possible horizontal transverse distance between two diametrically opposite zones Z1, Z2 of the inner peripheral edge of the frame. This maximum possible horizontal transverse distance corresponds to the largest dimension of the opening O, i.e., the diameter of the circle when the ring of the frame forms a circle.

The two lugs 35c, 35d are located at an altitude lower than that of the two zones Z1, Z2 that form crosspiece passage zones, as will be seen later.

It will be noted that the crosspieces 12 of the floor 10 of FIGS. 1 to 3 have a length (transverse dimension of the floor) that is smaller than the maximum possible horizontal transverse distance between two diametrically opposite zones Z1, Z2 of the inner peripheral edge of each frame that the floor must traverse. This arrangement allows the floor to traverse the central openings O of the frame 35 at the passage zones Z1, Z2 of the crosspieces (FIG. 6).

The nose 30 defines an inner space E to be integrated (FIGS. 4 and 5) that is open at the rear end 30b of the nose and closed at an opposite front end 30a of this same nose.

In reference to FIGS. 4 to 11, we will now describe a method for integrating a unified floor of an aircraft nose according to one embodiment of the invention.

The main steps of the method are illustrated in FIG. 11, which shows a flowchart of the method.

The method comprises a first step S1 for inserting the floor 10 (pre-equipped unified floor) inside the nose 30 by its rear end 30b.

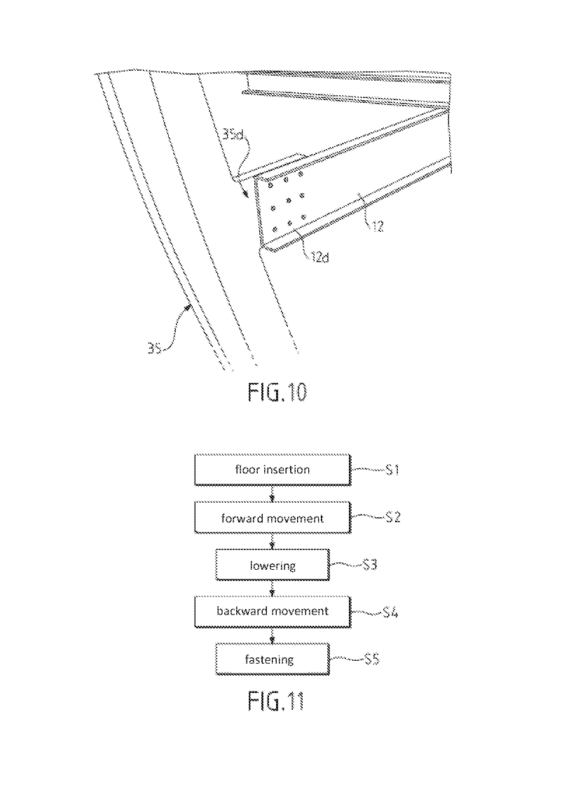

The insertion of the floor 10 is done along the longitudinal axis X toward the front end 30a of the nose, as illustrated in FIG. 5. In this figure, the floor 10 is subject to example tooling that will be described later in reference to FIGS. 4 and 5. However, the present description in reference to FIG. 10 is only concerned with the movements of the floor inside the nose. The means used to communicate these movements to the floor may assume different forms, like that, for example, assumed by the tooling shown in FIGS. 4 and 5.

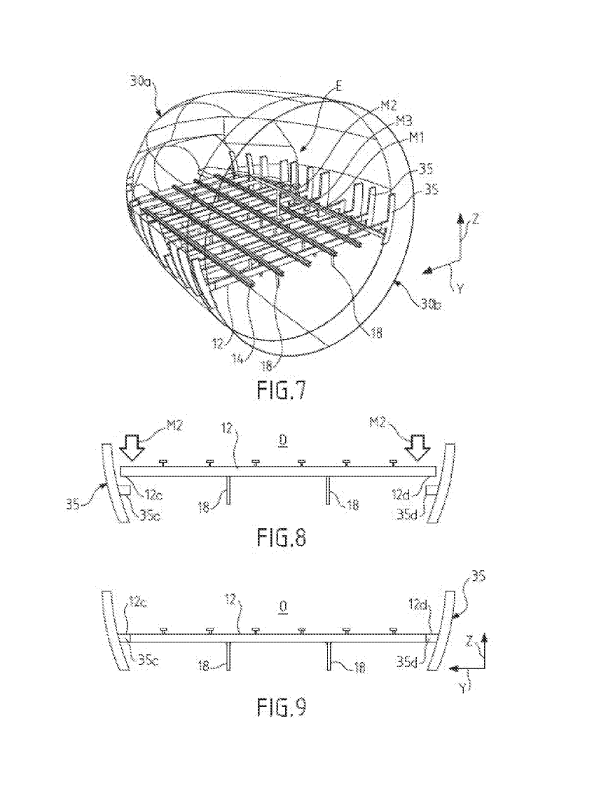

The method comprises a second step S2 for moving the floor 10 forward in the inner space to be integrated E, toward the front end 30a of the nose. As previously mentioned, during this forward movement, the floor 10 passes through the central openings O of the fuselage frames 35 at the passage zones Z1, Z2 of the crosspieces (these zones are the widest zones of each opening moving along the horizontal). This forward crossing movement of the frames is denoted M1 in FIG. 7.

During this movement, all of the crosspieces 12 of the floor traverse all of the frames 35 of the fuselage to which the floor will be fastened. It will be noted that toward the front end 30a, the space to be integrated E has a cross-section that becomes gradually smaller. The frames 35 also have dimensions that become gradually smaller. The crosspieces 12 that are situated close to the front end 10b of the floor have a length that also becomes smaller in proportion to the smaller transverse dimensions of the frames to be traversed.

During the following step S3 of the method, the floor is lowered vertically following the movement denoted M2 in FIGS. 7 and 8. This lowering movement of the floor makes it possible to bring the crosspieces of the floor to the same altitude as the offsetting lugs 35c and 35d of the frames 35 to which the floor will be fastened, as shown in FIG. 9. In this position, the opposite ends 12c, 12d of the crosspieces 12 are at the same altitude as the offsetting lugs 35c and 35d of the last frames respectively traversed by these crosspieces and to which the ends 12c, 12d will be fastened.

The method continues with a step S4 during which the floor is brought backward in the movement direction indicated by arrow M3 in FIG. 7.

This movement is a longitudinal movement along the axis X toward the rear end 30b of the nose, at the same altitude as that of the offsetting lugs of the frames. This backward movement is done until the opposite ends 12c, 12d of the crosspieces 12 are brought against the offsetting lugs 35c and 35d of the respective frames that form the docking support zones of the crosspieces. FIG. 10 is an enlarged illustration of one end 12d of a crosspiece after docking against the large face of an offsetting lug 35d. After docking, the crosspiece is fastened on the lugs of the frame (step S5). More particularly, the core of the crosspiece 12 is perforated at the end 12d so as to insert fastening elements (not shown) therein that traverse the lug through its thickness. The same is true for all of the crosspieces of the floor at each of their opposite end 12d, 12d.

The docking trajectory followed by the floor 10 (movements M1 to M3 in FIG. 7) make it possible to convey the floor to its final functional location reserved to accommodate it in the inner space E. It will be noted that in the absence of inner lugs on the inside of the frames, other, simpler trajectories for conveying the floor may be considered. Likewise, even in the presence of inner lugs on the inside of the frames, it is possible, according to one alternative that is not shown, to dock the lugs directly using a forward longitudinal approach without performing any backward movement. The opposite ends of the crosspieces are then fastened on the face of the lugs that is opposite that of FIG. 10.

We will now describe a method for integrating a unified floor of the nose according to one embodiment of the invention that, for example, uses installation tooling 40. The tooling 40 is installed in the nose 30 of the aircraft to convey the floor 10 toward its final installation location. This tooling is temporary, for the time needed to install the floor 10, previously formed from crosspieces and longitudinal elements and equipped with several separate sets of cables and/or other system circuits (e.g., oxygen conduits, etc.), for example as previously described.

As illustrated in FIG. 4, the tooling 40 is shown placed inside the nose 30 without the floor 10, for clarity reasons. The floor is, however, shown in FIG. 5, fastened to the tooling 40 and in the process of being installed in the nose 30.

The tooling 40 comprises a set of upper beams 42 (for example, two) and a set of lower beams 46 (for example, two) connected to the upper beams by lifting elements 48 such as wires. The upper beams on the one hand are rectilinear over a first non-curved part 42a of their length, and on the other hand, are curved downward over a second part 42b of their length. These forms allow the beams to adapt to the inner profile of the nose during a movement from the rear toward the front of the nose and as the cross-section becomes smaller.

The method according to one embodiment of the invention can thus comprise the following steps for the prior placement of the tooling 40:
a step for securing the two upper beams 42 to the frames 35 of the structure 33 of the aircraft 3, at the ceiling 34 with quick fastening means 44 (FIG. 4);
a step for securing the two lower beams 46 on two longitudinal elements 14 of the floor 10 (FIG. 5) in a known manner, the two lower beams 46 being fastened to the longitudinal elements 14 when the floor 10 (the unified module) is outside the aircraft (FIGS. 1 to 3);
a step for insertion, along the longitudinal axis X, of the floor 10 fastened to the lower beams 46 in the nose of the aircraft 3, through the open rear end 30b of the nose, such that the lower beams 46 wind up parallel to the upper beams 42, each upper beam 42 being located at a lower beam 46;
a step for fastening lifting wires 48 to the lower beams 46 and the upper beams 42, each wire 48 connecting an upper beam 42 to the lower beam 46 situated at the upper beam 12; the fastening of each wire 48 at the upper beam 42 is done via at least one roller 50 (FIG. 4) and via mechanical separators, not shown, between the wires; this fastening step is intended to suspend the floor 10 from the two upper beams 42, since no support exists in the structure 33 of the aircraft able to support the floor;
a step for actuating a driving system (not shown) to set the rollers 50 in motion along the upper beams 42 and move the floor 10 along the upper beams 42 via lifting wires 48 connected to the lower beams 46 secured to the floor,
a step for actuating a command and control system (not shown) to ensure optimized movement of the floor 10 along the upper beams 42, in particular with a readjustment of the length of each wire 48 at each moment of the movement of the floor 10 along the upper beams 42,
a step for moving the floor 10 toward the front end of the nose 30, this movement comprising a first horizontal component performed along non-curved parts 42a of the upper beams 42 at a constant altitude, followed by an oblique component along curved front parts 42b of the beams 42, allowing gradual lowering of the floor 10 in order to place it as precisely as possible in the nose 30, at the altitude of the lugs of the frames and in front of them (during this movement, the floor has performed the movements M1 and M2 of FIG. 7),
a step for horizontal movement of the floor 10 backward (movement M3 of the trajectory of FIG. 7), this movement being obtained by commanding the movement of the rollers 50 backward, while elongating the length of the lifting wires 48 (owing to a length adjusting device 51 commanded on each wire illustrated in FIGS. 4 and 5), over a short distance to allow the docking of the ends of the crosspieces on the lugs of the frames (the floor is thus brought into a final operational position),
a step for complete fastening of the floor in this functional position in the nose 30 of the aircraft, the fastening of the floor being done by fastening the crosspieces to the frames, as already explained,
a step for removing the tooling 40 made up of the upper beams 42, the lower beams 46, the lifting wires 48, the actuating system, the command and control system, once all of the operations to fasten the floor 10 in the nose have been performed.

After having fastened the crosspieces of the floor to the frames, the method may optionally include a step for placing diagonal elements, such as anti-crash (anti-accident) connecting rods. These diagonal elements are placed between two consecutive frames on the border of the floor. They serve to react the forces along the longitudinal axis X in case of crash or accident.

The floor 10, already assembled and equipped with cables, is a nose floor that is thus permanently installed in a single operation in the nose of the aircraft. This floor comprises the floor of the cockpit. According to one configuration, the nose floor is limited to the cockpit floor and the cabin floor (situated behind, in the cabin area) overflows to the inside of the nose to join the cockpit floor. According to another configuration, the nose floor is longitudinally more extensive than the cockpit floor and may even extend past the nose.

In general, the construction, outside the nose of an aircraft, of a nose floor using an interlacing of several parallel crosspieces and several parallel longitudinal elements (e.g., rails) provides a certain number of advantages:
the process of integrating the nose of the aircraft is made easier and faster, as is the construction/assembly of the floor outside the aircraft, where previously, the floor was built gradually in the nose of the aircraft, in a working environment that was difficult to access and cluttered;
the floor formed in one piece (with or without being equipped with its sets of cables and/or system circuits) can be installed quickly in a single operation in the nose of the aircraft when the fuselage is built;
such a floor has a simple architecture like that of an aircraft cabin.

When such a floor includes intermediate brackets (e.g., support connecting rods) for the crosspieces, the span of the crosspieces is reduced, which improves the rigidity of the crosspieces and makes it possible to reduce their size (thickness) for a same height. The crosspieces thus supported therefore have better flexural strength (flexion is their primary work mode). It will be noted that the crosspieces can also bear in a complementary manner on furniture or equipment positioned below the floor in the nose.

As an example, two intermediate brackets make it possible to reduce their span by about ⅓.

The arrangement of inner radial protuberances or offsetting lugs on the frames of the fuselage of the nose makes it possible to offset the docking zone with the crosspiece toward the inside of the frame. Such protuberances are for example made during the machining of the frames.

The presence of these protuberances on the frames makes it possible to use shorter crosspieces than before for fastening to the frames, which lightens the weight of the floor to be transported relative to a floor provided with non-shortened crosspieces. The crosspieces therefore do not attach on the core of the frames.

Shorter crosspieces make it possible not to interfere with the frames (cores of the frames) during the movement kinematics of the floor inside the nose and the crossing of the frames.

The kinematics described in reference to FIG. 7 (movements M1 to M3) are adapted to a floor structure with shorter crosspieces and the presence of internal offsetting lugs on the frames.

In general, the nose floor formed by the interlacing of several parallel crosspieces and several parallel longitudinal elements can be pre-equipped with cables, and optionally fluid conduits (e.g., oxygen), outside the nose.

The fastening of cables and/or conduits (or other system circuits) on the grid structure of the floor is thus done outside the aircraft. This operation is much simpler to perform than in the aircraft when the cables and/or conduits must be fastened from below the floor from tight and hard-to-access areas.

The grid structure of the floor can thus be dedicated to the circulation of cables and/or conduits and the routing plans for cables and/or conduits. These cables and/or conduits are, for example, cables intended for avionics equipment or systems, to connect them to one another, supply them with power, etc. The integration of cables and/or conduits into the floor can be done by organizing routing (circulation) plans or cable raceways in a simple and orderly manner. Thus, the cable raceways and/or conduits can be designed according to straight lines/plans without encountering obstacles on their passage requiring bypasses.

In general, the cables and/or conduits to be integrated into the floor are organized/brought together in sets of cables and/or conduits parallel to one another, each set comprising a plurality of cables and/or conduits parallel to one another in a same plane like a layer of cables and/or conduits. The sets are physically separated, and, in particular, fastened to components of the floor at different altitudes from one another. This makes it possible to produce simple routing plans, separate from one another (segregated), and also to fasten the cables and/or conduits homogenously: all of the cables and/or conduits fastened to the crosspieces are attached thereto in the same way, and the same is true for the cables and/or conduits fastened to the longitudinal elements. The fastening members are thus streamlined and may for example all be identical. By arranging the sets 20, 22, 24 described above so as to intersect one another, alternating from one set to the immediately adjacent set, it becomes possible to produce segregation by the distance of the systems to which the system circuits are connected (cables, conduits and other system circuits).

In a same extension plane comprising both cables and conduits, the cables (electricity) are positioned at a distance from the conduits (hydraulic and/or aeraulic) for segregation reasons. Most of the system circuits extend in the longitudinal direction X.

When all of the crosspieces and the longitudinal elements of the floor have the same height, this makes it possible to simplify the routing plans of the cables and/or conduits and to have rectilinear cable raceways. The circuits (cables, conduits, etc.) are for example all at the same minimal distance from the crosspieces. The fastening members or elements can thus all be the same and positioned as close as possible to the support structure.

It will be noted that the grid structure of the floor can be used, upstream, as a format grid for mounting power cable assemblies, which makes it possible to eliminate specific tooling.

The supports described above and used to fasten circuits (cables, conduits, etc.) are simple moving supports fastened to the crosspieces and the longitudinal elements. When, for example, all of the crosspieces of the floor have the same height, the fastening of the moving supports on the crosspieces is done uniformly.

The environment of the floor on board the aircraft is simplified, since no, or almost no, stationary supports are needed on the structure of the aircraft, as was previously the case, and which are expensive. Such supports are intermediate metal parts positioned between the moving supports in the crosspieces and which weaken the structures. Owing to the novel arrangement of the sets of circuits on the grid structure of the floor and their fastening via moving supports, several hundred parts are eliminated.

It will be noted that the preceding description of sets of cables mentioned the presence of strands each bringing together a plurality of cables. In one alternative that is not shown, each strand may be reduced to a single cable.

Furthermore, the longitudinal elements 14 described above are in particular used to fasten a tooling, like that described above, for placement of the floor in the nose. When it involves rails, they may also be used to fasten seats.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-15. (canceled)

16. An aircraft nose floor comprising:
a grid structure formed by interlacing crosspieces parallel to one another, and
longitudinal elements parallel to one another and fastened to the crosspieces,
the grid structure incorporating at least one of cables or conduits that are fastened to the structure,
the floor and the at least one of cables or conduits forming a unified module that is configured to be transported in a single piece,
the at least one of cables or conduits incorporated into the structure being grouped together in several separate sets of at least one of cables or conduits,
the structure having a height that extends perpendicular to extension directions of the crosspieces and longitudinal elements,
the separate sets of at least one of cables or conduits extending in separate extension planes that are respectively distributed with different altitudes relative to the height of the structure.

17. The floor according to claim 16, wherein the extension planes of the separate sets of at least one of cables or conduits are parallel to one another and situated at different altitudes from one another, each set including several at least one of cables or conduits or several subsets of at least one of cables or conduits that extend parallel to one another in a same plane and at a same altitude.

18. The floor according to claim 16, wherein the separate sets of at least one of cables or conduits are positioned so as to intersect one another.

19. The floor according to claim 18, wherein at least one set of at least one of cables or conduits is positioned parallel to the crosspieces and at least one set of at least one of cables or conduits is positioned parallel to the longitudinal elements.

20. The floor according to claim 16, wherein at least one set of at least one of cables or conduits is fastened to crosspieces and at least one set of at least one of cables or conduits is fastened to longitudinal elements.

21. The floor according to claim 20, wherein several crosspieces each comprise a lower soleplate and an upper soleplate and are each provided, at each soleplate, with at least one fastening support for fastening at least one cable or conduit of a set of at least one of cables or conduits that extends parallel to the longitudinal elements.

22. The floor according to claim 20, wherein each longitudinal element is provided, in its lower part, with at least one support for fastening at least one cable and/or conduit of a set of at least one of cables or conduits that extends parallel to the crosspieces.

23. An aircraft nose comprising a floor according to claim 16.

24. The aircraft nose according to claim 23, wherein the nose extends longitudinally and comprises a plurality of transverse fuselage frames parallel to one another that surround the floor, each fuselage frame extending in a cross-section and bordering, by an inner peripheral edge, a central opening, at least some of the crosspieces of the floor each being fastened by their two opposite ends respectively to two facing radial protuberances of a fuselage frame, the two protuberances of the frame extending radially in the central opening of the frame toward one another from the inner peripheral edge of said frame.

25. The aircraft nose according to claim 24, wherein each crosspiece of the floor has a length smaller than the longest transverse distance that extends between two diametrically opposite zones of the inner peripheral edge of each frame that the crosspiece has traversed to place the floor.

26. The aircraft nose according to claim 25, wherein the two radial protuberances of each frame are respectively situated at an altitude lower than that of the two diametrically opposite zones of the inner peripheral edge of each frame.

27. The aircraft nose according to claim 23, wherein the floor comprises at least one intermediate bracket for at least some of the crosspieces, the at least one intermediate bracket being positioned below the crosspieces.

28. A method for integrating a floor of an aircraft nose, the nose defining an inner space to be integrated that extends along a longitudinal axis, the inner space to be integrated being open at a so-called rear end of the nose and closed at an opposite front end of said nose, wherein the method includes the following steps:
inserting a nose floor according to claim 16 into the nose, the insertion of the floor being done along the longitudinal axis via the rear end of the nose,
moving the floor in the inner space to be integrated, toward the front end of the nose until reaching a location reserved to accommodate the floor.

29. The method according to claim 28, wherein the nose comprises a plurality of parallel transverse fuselage frames, each fuselage frame extending in a cross-section and bordering, by an inner peripheral edge, a central opening, the crosspieces of the floor each having a length that is smaller than the largest transverse distance that extends between two diametrically opposite zones of the inner peripheral edge of each frame such that the crosspieces of the floor pass between the frames, at the altitude of said two diametrically opposite zones of each frame, called crosspiece passage zones, during the forward movement of the floor toward the front end of the nose.

30. The method according to claim 29, wherein each frame includes two facing radial protuberances that extend radially in the central opening of the frame toward one another from the inner peripheral edge of said frame, the two radial protuberances of each frame being situated at an altitude lower than that of the two crosspiece passage zones and forming docking support zones for the crosspieces, the method further comprises:
after the passage of the floor between the frames to which the floor must be fastened, at the altitude of the crosspiece passage zones and toward the front end of the nose, lowering of the floor to the altitude of the two docking support zones of each traversed frame, then a return backward of the floor so that the two opposite ends of each crosspiece are respectively brought against the two docking support zones of the crosspieces of the traversed frame, and fastened to the traversed frame.
